(19) United States
(12) Patent Application Publication
(10) Pub. No.: US 2011/0038244 A1
(43) Pub. Date: Feb. 17, 2011

(54) WRITING METHOD FOR MULTILAYER OPTICAL DISC

(75) Inventors: Chao-Chun Huang, Taoyuan County (TW); Song-Rui Chen, Taoyuan County (TW)

Correspondence Address: RABIN & Berdo, PC, 1101 14TH STREET, NW, SUITE 500, WASHINGTON, DC, 20005, US

(73) Assignee: QUANTA STORAGE INC., Taoyuan County (TW)

(21) Appl. No.: 12/849,914

(22) Filed: Aug. 4, 2010

(30) Foreign Application Priority Data
Aug. 17, 2009 (TW) 098127668

(51) Int. Cl. G11B 7/20

(52) U.S. Cl. 369/94; G9B/7.137

(57) ABSTRACT

A writing method for a multilayer optical disc. The method includes: measuring and recording optimum internal gains obtained when the objective lens is located on each inner side of the pick-up head, respectively, checking the writing direction based on the specific writing direction on each data layer of the disc, selecting the inner optimum internal gain when the writing direction is toward outside, and selecting the opposite inner optimum internal gain when the writing direction is toward inside to minimize the offset of the tracking error signal.

This application claims the benefit of Taiwan application Serial No. 98127668, filed Aug. 17, 2009, the subject matter of which is incorporated herein by reference.

### BACKGROUND OF THE INVENTION

1. Field of the Invention

The invention relates in general to an optical disc drive, and more particularly to an optical disc drive which writes data on data layers in a multi-layer optical disc along different writing directions.

2. Description of the Related Art

Optical disc drive emits micro spots whose diameter range 0.85˜2.11 μm on an optical disc, and accordingly receives a reflection light from the optical disc. The electrical signal, formed by the difference in the amount of the reflection light, further controls the optical disc drive to read data along the data tracks on the optical disc. Since the reflection spots are very tiny, the electrical signals converted from the reflection spots are also very weak. To stably control the tracking to improve writing quality on the optical disc, the converted electrical signals need to be amplified and the reflection spots must be projected at correct positions.

As indicated in FIG. 1, a conventional tracking control method for an optical disc drive 1 according to prior art is shown. By the differential push pull (DPP) method, a light beam is projected onto the optical disc 3 from the pick-up head 2 and a reflection light, reflected from the optical disc 3, is received by the photosensitive device 4. The photosensitive device 4 includes a main photosensitive portion 4a and two sub-photosensitive portions 4b and 4c. The main photosensitive portion 4a includes the reception portions A, B, C and D; the sub-photosensitive portion 4b includes the reception portions E and F; and the sub-photosensitive portion 4c includes the reception portions G and H. The reflection light includes three reflection spots 5a, 5b and 5c which are respectively projected onto the main photosensitive portion 4a and the two sub-photosensitive portions 4b and 4c. The main photosensitive portion 4a receives the reflection spot 5a via the reception portions A, B, C and D to form a main push pull signal (MPP), wherein MPP=(A+D)−(B+C). The two sub-photosensitive portions 4b and 4c receive the reflection spots 5b and 5c via the reception portions E-F and G-H respectively to form a sub-push pull signal (SPP), wherein SPP=(F+H)−(E+G). The tracking error (TE) signal is expressed as: TE=K*(MPP−Ks*SPP). The external gain K is used for amplifying the tracking error signal. When the projected light beam is vertically aligned to the data tracks 6, optimum internal gains are determined based on the internal gain Ks so that the tracking error signal satisfies TE=0 and also the light beam is controlled to be locked along the data tracks 6 through the change in the tracking error signal TE.

However, in determining the optimum internal gain, the objective lens 7 which projects a light beam is normally located at the center of the pick-up head 2. Due to the optical structure of the pick-up head 2, when the micro-actuator 8 moves the objective lens 7 off the center, particularly during writing on a multi-layer optical disc, the objective lens 7 will skew to one side because the writing directions on each layer are different from each other; and the projection positions of the reflection spots 5a, 5b and 5c will have offset, as indicated by the dotted lines. The state of light received by the reception portions A, B, C, D, E, F, G and H changes accordingly. The optimum internal gain previously determined is no longer optimum; the position at which the tracking error signal TE=0 already shifts; and the projected light beam is not correctly locked on the data tracks 6. The movement of the pick-up head 2 is not controlled precisely. Consequently, writing on the optical disc is negatively affected, and the signal quality and the reliability are deteriorated. Thus, there still have many problems occurred in writing on data layers of the multi-layer optical disc.

### SUMMARY OF THE INVENTION

One aspect of the invention is directed to a writing method for writing a multi-layer optical disc. Based on the optimum internal gains obtained when the objective lens are on sides of the pick-up head, respectively, the offset of the tracking error signal, which occurs when the objective lens is moved off the center of the pick-up head, is minimized.

Another aspect of the present invention is directed to a writing method for writing a multi-layer optical disc. According to the writing direction on each data layer of the optical disc, one from the optimum internal gains is selected for enhancing the stability of writing on each data layer.

In a writing method for a multi-layer optical disc according to the aforementioned aspects of the invention, measuring and recording optimum internal gains obtained when the objective lens is located on each inner side of the pick-up head, respectively, checking the writing direction based on the specific writing direction on each data layer of the disc, selecting the inner optimum internal gain when the writing direction is toward outside, and selecting the opposite inner optimum internal gain when the writing direction is toward inside to generate the tracking error signal for data writing.

Provided is a writing method for a multi-layer optical disc according to measuring a level of the tracking error signal when the objective lens is located at a center of the pick-up head as a reference level; moving the objective lens off the center of the pick-up head and towards one inner side of the pick-up head and aligning the objective lens to data tracks; measuring the level of the tracking error signal based on a pre-determined negative internal gain and further deducting the measured level by the reference level to obtain an offset of the tracking error signal under the negative internal gain; measuring the level of the tracking error signal based on a pre-determined positive internal gain and further deducting the measured level by the reference level to obtain the offset of the tracking error signal under the positive internal gain; obtaining the optimum internal gain related to the inner side by interpolating the offsets of the tracking error signal under the positive and the negative internal gains; and if the measurement is not yet completed, then the objective lens is moved towards the other inner side of the pick-up head, and the measurement is continued until measurement of the optimum internal gains obtained when the objective lens is towards the opposite inner sides of the pick-up head is completed.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a tracking control method for a prior optical disc drive;

FIG. 2 shows outward movement of a pick-up head along outer tracks of an optical disc;

FIG. 3 shows inner movement of the pick-up head along inner tracks of an optical disc;

FIG. 4 shows a process of setting one inner optimum internal gain according to an embodiment of the invention;

FIG. 5 shows a flowchart of writing a multi-layer optical disc according to a first embodiment of the invention; and

FIG. 6 shows a flowchart of writing a multi-layer optical disc according to a second embodiment of the invention.

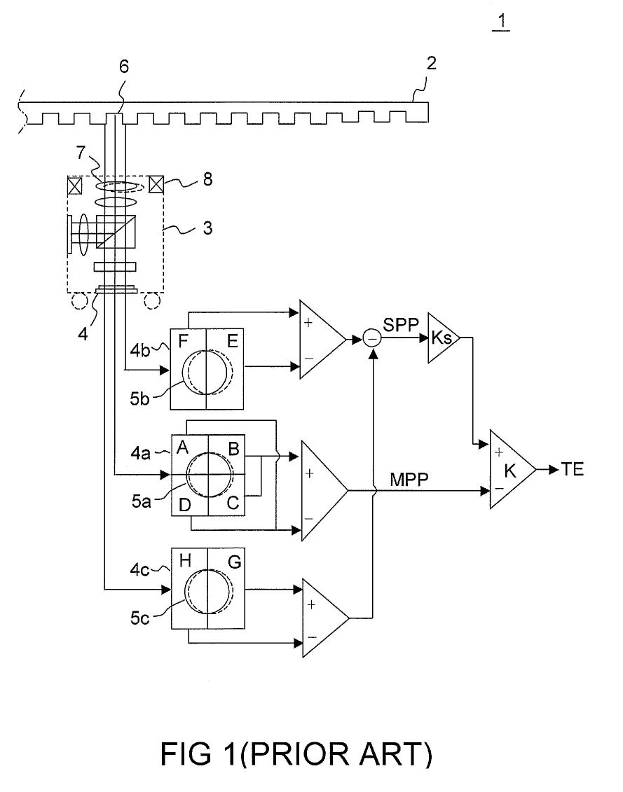

### DETAILED DESCRIPTION OF THE INVENTION

The technologies and their effects adopted in the invention for achieving the above objects are disclosed below in a number of embodiments with accompanying drawings.

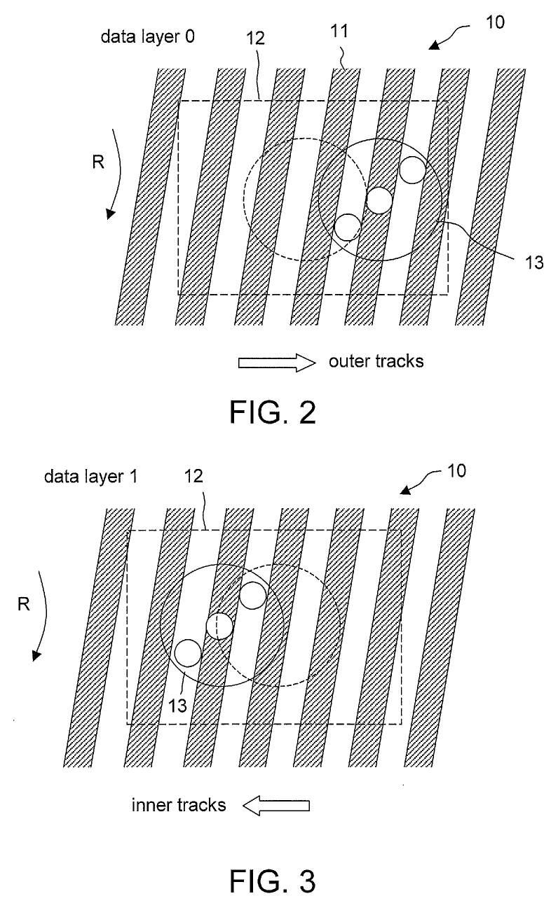

Referring to FIG. 2, movement of a pick-up head along outer tracks of an optical disc is shown. The data tracks 11 of the optical disc 10 have spiral threads from inner tracks to outer tracks of the optical disc 10. The pick-up head 12 is controlled to move along the data tracks 11 based on a tracking error signal formed by three light beams projected by the objective lens 13. During the tracking movement, after the pick-up head 12 is moved via coarse adjustment, as for the data tracks 11 covered by the pick-up head 12, the pick-up head 12 does not move but the micro-actuator moves the objective lens 13 along the data tracks 11. Thus, when the pick-up head 12 moves towards the outer tracks of the optical disc 10 for writing data, the objective lens 13 skews, from the center (illustrated in dotted lines) of the pick-up head 12, to the inner (right) side inside the pick-up head 12. Consequently, the offset of optical structure changes, the optimum internal gain, which is obtained when the objective lens 13 is at the center of the pick-up head 12, cannot lock and move the pick-up head 12 at correct positions on the data tracks 11 and data will thus be written at incorrect positions. Referring to FIG. 3, movement of the pick-up head 12 along inner tracks of an optical disc is shown. To the contrary, when the pick-up head 12 moves towards the inner tracks of the optical disc 10 to write data, the objective lens 13 skews, from the center (illustrated in dotted lines) of the pick-up head 12, to the opposite inner (left) side inside the pick-up head 12. Similarly, the offset of optical structure changes, the optimum internal gain, which is obtained when the objective lens 13 is at the center of the pick-up head 12, are no longer applicable, and the optimum internal gains determined when the objective lens 13 skews towards the inner side inside the pick-up head 12 are not applicable either.

For a multi-layer optical disc, each data layer has a specific writing direction, and adjacent data layers have opposite writing directions. Let a dual-layer optical disc be taken for example. The writing direction of the 0-th data layer is towards the outer tracks of the optical disc 10, but the writing direction of the first data layer is towards the inner tracks of the optical disc 10. Thus, in writing a multi-layer optical disc, optimum internal gains are selected according to whether the writing direction is towards the inner tracks or towards the outer tracks of the optical disc 10, so as to generate a correct tracking error signal, to minimize the offset in tracking positions and to assure the writing stability.

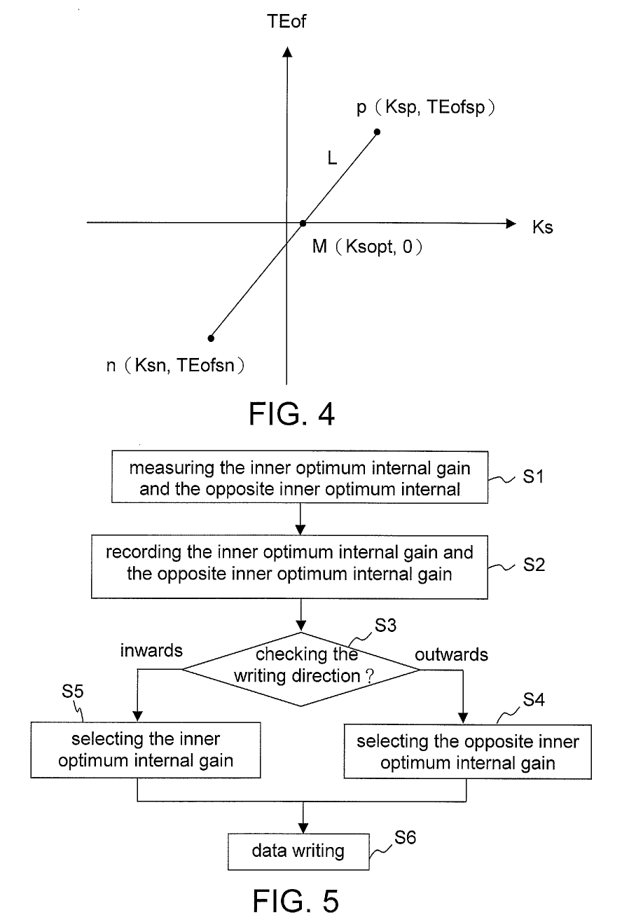

As indicated in FIG. 4, a process of setting the optimum internal gain if the objective lens is skew to the inner side inside the optical pick-up according to one embodiment of the invention is shown. Firstly, the objective lens is located at the center of the pick-up head and aligned to the data tracks, and the level (for example, the DC level) of the tracking error signal is measured to be as a reference level TEr for the tracking error signal. Next, the objective lens is moved off the center of the pick-up head, and the objective lens moves towards the inner side inside the pick-up head and is aligned to the data tracks, the level of the tracking error signal TEn=K*(MPP−Ksn*SPP) is measured based on the pre-determined negative internal gains Ksn (for example, Ksn=−6 db). The level TEn is deducted by the reference level TEr to obtain the offset TEofsn of the tracking error signal (that is, TEofsn=TEn−TEr) when the negative internal gains Ksn=6 db, and to obtain a point n (Ksn,Teofsn). Then, the tracking error signal TEp (that is, TEp=K*(MPP−Ksp*SPP)) is measured based on the predetermined positive internal gains Ksp (for example, Ksp=6 db). TEp is deducted by the reference level TEr to obtain the offset TEofsp of the tracking error signal (that is, TEofsp=TEp−TEr) when positive internal gains Ksp=6 db, and to obtain a point p (Ksp,Teofsp). Through the intersection point M between the offset straight line L (formed by the point p and the point n) and Teofs=0, the inner optimum internal gain Ksopt can be obtained promptly.

Likewise, the objective lens is moved off the center of the pick-up head, the objective lens moves towards the opposite inner side inside the pick-up head and is aligned to the data tracks, and the opposite inner optimum internal gain Ksopt can be obtained according to the process similar to that of obtaining the inner optimum internal gain. Before the writing process, the optical disc drive can measure and record the inner optimum internal gain and the opposite inner optimum internal gain first. Or, during writing, the optical disc drive measures the inner optimum internal gain and the opposite inner optimum internal gain, checks whether the objective lens moves towards the inner side or the opposite inner side inside the pick-up head according to the writing direction on the optical disc, and selects from the inner optimum internal gain and the opposite inner optimum internal gain, so as to correct the offset of the tracking error signal and to achieve correct writing.

As indicated in FIG. 5, a flowchart of writing a multi-layer optical disc according to a first embodiment of the invention is shown. Disclosed below are steps of measuring the inner optimum internal gain and the opposite inner optimum internal gain before writing data, to correct the offset of the tracking error signal. Firstly, at step S1, the optimum internal gains obtained when the objective lens is on the inner side and the opposite inner side of the pick-up head are respectively measured. Next, at step S2, the inner optimum internal gain and the opposite inner optimum internal gain are recorded. Then, at step S3, the writing direction of the optical disc is checked; and whether the objective lens is towards inner side or opposite inner side of the pick-up head is determined according to the specific writing direction on the optical disc. If the writing direction is outwards, at step S4, the opposite inner optimum internal gain is selected to generate a tracking error signal for locking and moving along data tracks, and the method proceeds to step S6 for data writing. If the writing direction is inwards, at step S5, the inner optimum internal gain is selected to generate a tracking error signal for locking and moving along data tracks, and the method proceeds to step S6 for data writing.

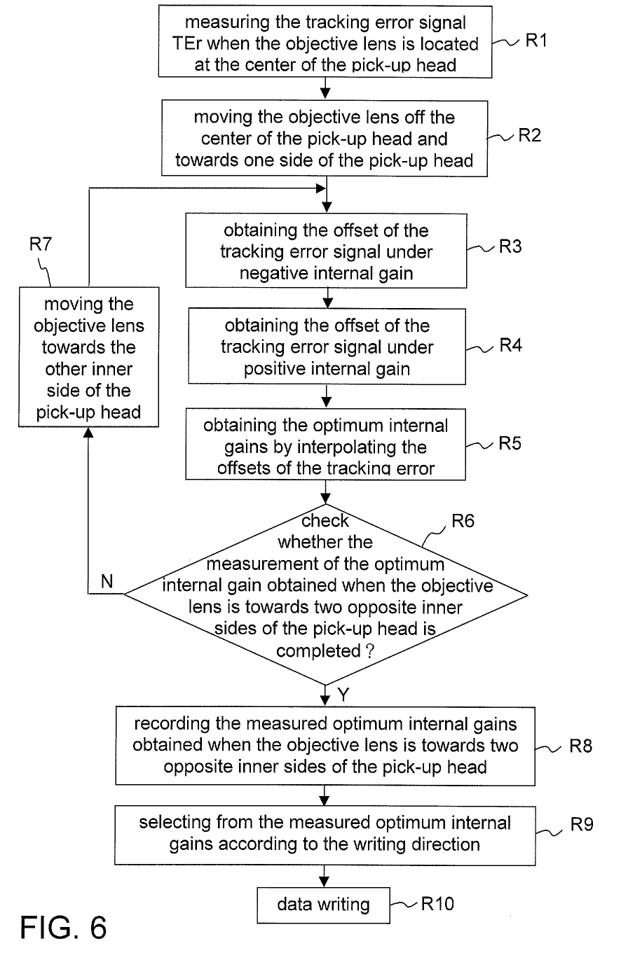

As indicated in FIG. 6, a flowchart of writing a multi-layer optical disc according to a second embodiment of the invention is shown. Disclosed below are steps of measuring the inner optimum internal gain and the opposite inner optimum internal gain during writing data, to correct the offset of the tracking error signal. Firstly, at step R1, the DC level of the tracking error signal when the objective lens is located at the center of the pick-up head is measured and used as a reference level TEr for the offset of the tracking error signal. Next, at step R2, the objective lens is moved off the center of the pick-up head and towards one inner side of the pick-up head and is aligned to the data track. Then, at step R3, the DC level of the tracking error signal is measured based on the pre-determined negative internal gain, and the measured DC level of the tracking error signal is deducted by the reference level TEr to obtain an offset TEofsn of the tracking error signal under negative internal gain. At step R4, the DC level of the tracking error signal is measured based on the pre-determined positive internal gain, and the measured DC level of the tracking error signal is deducted by the reference level TEr to obtain an offset TEofsp of the tracking error signal under positive internal gain. Afterwards, at step R5, an offset line is formed based on the offset TEofsn of the tracking error signal under negative internal gain and the offset TEofsp of the tracking error signal under positive internal gain; optimum internal gain when the objective lens is at the inner side of the pick-up head is obtained by interpolation when the offset of TE is zero.

Then, at step R6, checked is whether the measurement of the optimum internal gains obtained when the objective lens is towards two opposite inner sides of the pick-up head, respectively, is completed. If the measurement is not yet completed, then the method proceeds to step R7, the objective lens is moved towards the opposite inner side of the pick-up head, and the method returns to step R3 to continue the measurement. If the measurement is completed, then the method proceeds to step R8, the measured optimum internal gains obtained when the objective lens is towards two opposite inner sides of the pick-up head, respectively, are recorded and used in selection for writing the optical disc. Then, at step R9, during the writing process, selected is one from the measured optimum internal gains according to the writing direction for generating a tracking error signal. Lastly, at step R10, the writing of optical disc is performed.

According to the writing method for a multi-layer optical disc in the above embodiments of the invention, whether the objective lens is towards one of the two opposite inner sides of the pick-up head is determined according to the writing direction on each data layer of the optical disc, and the optimum internal gain is selected, so that the offset of the tracking error signal, which occurs when the objective lens is moved off the center of the pick-up head, is minimized, and the stability of writing on each data layer is enhanced.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A writing method for a multi-layer optical disc, comprising:
(1) measuring an inner optimum internal gain and an opposite inner optimum internal gain obtained if an objective lens is located on opposite inner sides of a pick-up head, respectively;
(2) recording the inner optimum internal gain and the opposite inner optimum internal gain;
(3) checking a writing direction on the optical disc: if the writing direction is towards outside, then the inner optimum internal gain is selected to generate a tracking error signal and the method proceeds to step (4); if the writing direction is towards inside, then the opposite inner optimum internal gain is selected to generate the tracking error signal, and the method proceeds to step (4); and
(4) performing writing.

2. The writing method for the multi-layer optical disc according to claim 1, wherein the writing direction is determined according to a writing direction on a data layer of the multi-layer optical disc.

3. The writing method for the multi-layer optical disc according to claim 2, wherein each data layer of the multi-layer optical disc has a specific writing direction.

4. The writing method for the multi-layer optical disc according to claim 3, wherein the writing directions on adjacent data layers of the multi-layer optical disc are opposite.

5. The writing method for the multi-layer optical disc according to claim 3, wherein the multi-layer optical disc has two data layers, the writing direction of a 0-th data layer is towards outside, but the writing direction of a first data layer is towards inside.

6. The writing method for the multi-layer optical disc according to claim 1, wherein the measuring step (1) comprises:
(1-1) measuring a level of the tracking error signal when the objective lens is located at a center of the pick-up head as a reference level;
(1-2) moving the objective lens off the center of the pick-up head and towards one inner side of the pick-up head and aligning the objective lens to data tracks;
(1-3) measuring the level of the tracking error signal based on a pre-determined negative internal gain and further deducting the measured level by the reference level to obtain an offset of the tracking error signal under the negative internal gain;
(1-4) measuring the level of the tracking error signal based on a pre-determined positive internal gain and further deducting the measured level by the reference level to obtain the offset of the tracking error signal under the positive internal gain;
(1-5) obtaining the optimum internal gain related to the inner side by interpolating the offsets of the tracking error signal under the positive and the negative internal gains; and
(1-6) checking whether measurement of the optimum internal gains obtained when the objective lens is towards the opposite inner sides of the pick-up head is completed; if the measurement is not yet completed, then the objective lens is moved towards the other inner side of the pick-up head, and the method returns to step (1-3) to continue the measurement, and if the measurement is completed, then the method proceeds to step (2).

7. The writing method for the multi-layer optical disc according to claim 6, wherein the offset of the tracking error signal under the negative internal gain and the offset of the tracking error signal under the positive internal gain form an offset line; and an optimum internal gain is obtained by interpolation under the offset is zero.

8. The writing method for the multi-layer optical disc according to claim 6, wherein the positive internal gain is 6 db, and the negative internal gain is −6 db.

9. The writing method for the multi-layer optical disc according to claim 6, wherein the measured level of the tracking error signal is DC current level.
